(19) United States
(12) Patent Application Publication
(10) Pub. No.: US 2014/0268814 A1
(43) Pub. Date: Sep. 18, 2014

(54) CUSTOMIZED SIGNATURE DECORATIVE LAMP

(71) Applicant: CHIN-SHENG YANG, Tainan City (TW)

(72) Inventor: CHIN-SHENG YANG, Tainan City (TW)

(21) Appl. No.: 13/798,174

(22) Filed: Mar. 13, 2013

(51) Int. Cl. F21V 1/00

(52) U.S. Cl. CPC F21V 1/00
USPC 362/311.02

(57) ABSTRACT

A customized signature decorative lamp is provided, mainly containing: a shell, a base and a projection film. The shell is a light-transmittable three-dimensional shape, and has a downward opening. The base is disposed correspondingly at the bottom of the shell to seal the opening, and includes a light-emitting element corresponding to the inside of the shell. The projection film is disposed inside the shell and surrounds the light-emitting element. The projection film has customized signature pattern able for light to pass through. As such, when the light-emitting element projects light onto the projection film, the customized signature pattern can be projected onto the shade so that the lamp of the present invention can display personalized decoration.

### (A) TECHNICAL FIELD OF THE INVENTION

The present invention generally relates to a customized signature decorative lamp, and more particularly to a decorative lamp able to accept customized signature, applicable to display in an ambient space.

### (B) DESCRIPTION OF THE PRIOR ART

As the technology, culture and social progress in many aspects, people are pursuing higher quality in daily lives, in particular, the living environment at home.

In daily life, the home decoration utilizes decorative objects to improve visual esthetics, such as, household furnishing and other objects with decorative patterns. However, the majority of decorative pattern designs may not meet the need of the customers, and more and more customers look for personalized and unique decorations for self-expression as well as creating a unique personal space at home.

Therefore, it is desirable to devise a lamp able to display customized signature in addition to decorative capability so as to enhance the esthetics of the household.

### SUMMARY OF THE INVENTION

The primary purpose of the present invention is to provide a novel and independent automatic device herein that utilizes existing wiring for turning on and off audio playing.

The present invention provides a customized signature decorative lamp, mainly containing: a shell, being a light-transmittable three-dimensional shape, having a downward opening; a base, disposed correspondingly at the bottom of the shell to seal the opening, and being disposed with a light-emitting element corresponding to the inside of the shell; and a projection film, disposed inside the shell and surrounding the light-emitting element, the projection film having customized signature pattern able for light to pass through.

As such, when the light-emitting element projects light onto the projection film, the customized signature pattern can be projected onto the shade so that the lamp of the present invention can display personalized decoration.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram according to the invention.

FIG. 2 is a dissected perspective diagram according to the invention.

FIG. 3 is a cross-sectional diagram according to the invention.

FIG. 4 is a perspective diagram showing the projection according to the invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Refer to FIGS. 1-3, which are perspective diagram, dissected perspective diagram and cross-sectional diagram of the present invention, respectively. The customized signature decorative lamp of the present invention includes a shell 1, a base 2 and a projection film 3. The shell 1 is fixedly engaged to the top of the base 2 and the projection film 3 is disposed inside the shell 1.

The shell 1 can show a light-transmittable three-dimensional shape and has a downward opening. In the present embodiment, the shell 1 is shown as a snowman, but it not limited to the illustrative shape.

The base 2 is correspondingly disposed at the bottom of the shell 1 and seals the opening 11 of the shell 1. A light-emitting element 21 is disposed inside the base 2 corresponding to the shell 1.

The projection film 3 is disposed inside the shell 1 and surrounds the light-emitting element 21. The surface of the projection film 3 includes a customized signature pattern 31. In the present embodiment, the projection film 3 is a film made of plastic. Other than the customized signature pattern 31, the remaining part of the projection film 3 is opaque and not light-transmittable.

Accordingly, the customized signature pattern 31 can be a personal name or a signature, which can be formed by using laser engraving to form auxiliary patterns with reserved space for the signature. The signature can be written by the customer and engraved by computer engraving to form personal signature. The projection film 3 can also be an extension part of the base 2.

The light-emitting element 21 is designed as a light-emitting diode (LED), and disposed correspondingly to the inside of the shell 1. The light-emitting element 21 can provide a variety of light colors to further enhance the visual effect of the present invention. The powering of the light-emitting element 21 is controlled by a switch 22, with power from battery, or AC, DC, and so on. As various power sources can be used, and is not within the scope of the present invention, the description will be omitted here.

Referring to FIG. 4, the light-emitting element 21 projects light on the projection film 3 so as to project the customized signature pattern 31 on the shell 1. As such, a decorative lamp with customized signature is formed.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A customized signature decorative lamp, mainly comprising:
a shell, being a light-transmittable three-dimensional shape, having a downward opening;
a base, disposed correspondingly at the bottom of the shell to seal the opening, and being disposed with a light-emitting element corresponding to the inside of the shell; and
a projection film, disposed inside the shell and surrounding the light-emitting element, the projection film having customized signature pattern able for light to pass through.

2. The customized signature decorative lamp according to claim 1, wherein the customized signature pattern is formed by laser engraving.

3. The customized signature decorative lamp according to claim 1, wherein the projection film is an extension part from the base.
